(19) United States
(12) Patent Application Publication
(10) Pub. No.: US 2023/0258520 A1
(43) Pub. Date: Aug. 17, 2023

(54) SCREW NUT AND MOUNTING DEVICE

(71) Applicant: MICRO-SENSYS GMBH, Erfurt (DE)

(72) Inventors: Reinhard JURISCH, Bad Berka (DE); Peter PEITSCH, Erfurt (DE)

(21) Appl. No.: 18/003,299

(22) PCT Filed: Jun. 22, 2021
(86) PCT No.: PCT/EP2021/066916

§ 371 Date: Dec. 23, 2022

(30) Foreign Application Priority Data
Jun. 24, 2020 (DE) 10 2020 116 618.4

(51) Int. Cl. G01L 5/24; F16B 37/00; G01L 1/22

(52) U.S. Cl. CPC G01L 5/24; F16B 37/00; G01L 1/2218

(57) ABSTRACT

The invention relates to a screw nut (1) with a sensor module (5) for determining a pretensioning force of a screw connection, wherein the sensor module (5) comprises at least one deformation detection sensor (7) arranged on a base body (6) of the screw nut (1) for detecting a deformation of the base body (6) of the screw nut (1) and an RFID transponder unit (8), and wherein a printed circuit board (9) of the sensor module (5), on which an antenna (10) of the RFID transponder unit (8) and an electronic circuit of the sensor module (5) are formed and which is electrically conductively coupled to the at least one deformation detection sensor (7), is arranged on an end face (11) of the base body (6). Furthermore, the invention relates to a mounting device (2).

The invention relates to a screw nut and an assembly device.

From the prior art, as described in DE 10 2009 038 211 A1, a device for determining and/or monitoring a pretensioning force of a screw connection is known. The device comprises a sensor for determining and/or monitoring the pretensioning force of the screw connection, which sensor generates data that are dependent on the value of the pretensioning force and/or on a change in the pretensioning force, a transmitting unit for transmitting the data of the sensor, and an energy source that supplies the sensor and/or the transmitting unit with electrical energy.

The object of the invention is to specify a screw nut which is improved compared with the prior art and an assembly device which is improved compared with the prior art.

The object is achieved according to the invention by a screw nut with the features of claim 1 and by an assembly device with the features of claim 11.

Advantageous embodiments of the invention are the subject of the dependent claims.

A screw nut according to the invention comprises a sensor module for determining a pretensioning force of a screw connection to be produced or having been produced by means of the screw nut, wherein the sensor module comprises at least one deformation detection sensor arranged on a base body of the screw nut for detecting a deformation of the base body of the screw nut and an RFID transponder unit, and wherein a printed circuit board of the sensor module is arranged on an end face of the base body, for example is arranged directly thereon or is arranged on, for example, a layer arranged between the printed circuit board and the end face, the layer for example resting on the end face. The printed circuit board is in particular attached, in particular mounted, to this end face of the base body. In particular, an antenna of the RFID transponder unit and an electronic circuit of the sensor module are formed on the printed circuit board. Advantageously, the entire RFID transponder unit is arranged on the printed circuit board. The printed circuit board is electrically conductively coupled to the at least one deformation detection sensor.

The screw nut according to the invention is a telemetric screw nut, which, in particular due to the RFID technology, enables a contactless determination of the pretensioning force of the screw connection to be produced or having been produced by means of the screw nut, since the data transmission between the sensor module, in particular its RFID transponder unit, and an RFID reader unit takes place wirelessly via an electromagnetic field and thus by means of a radio transmission. Furthermore, it is not necessary for the screw nut to have an electrical energy source to operate the sensor module, because by means of RFID technology the transmission of electrical energy from the RFID reader unit to the sensor module also takes place by means of the electromagnetic field. However, the sensor module, in particular the RFID transponder unit, can have, for example, a rechargeable electrical energy storage device, in particular a capacitor, for storing, at least temporarily, the electrical energy transmitted by the RFID reader unit, as will be explained below.

The printed circuit board is expediently annular in shape, in particular, at least substantially, circular or elliptical or with a hexagonal outer contour. In this case, a clear width of a feed-through opening of the printed circuit board and, expediently, also of the entire sensor module is at least as large as a clear width of a screw opening of the base body of the screw nut, in order to allow the screw nut to be screwed onto a screw or a threaded bolt or a threaded rod. Thus, in the case of a round lead-through opening, a diameter of the lead-through opening is at least as large as a diameter of the screw opening. Advantageously, the clear width of the lead-through opening and, in the case of a round lead-through opening, its diameter is larger than the clear width or the diameter of the screw opening.

The at least one deformation detection sensor is advantageously arranged in the region of an outer circumferential side of the base body. For example, it is arranged on a side surface, i.e., on a tool engagement surface portion, or it is arranged, for example, in a cavity formed in a side surface, or it is arranged, for example, in an axial bore in the region of an edge between two adjacent side surfaces. A base body of the screw nut designed as a hexagon screw nut has six such side faces and six edges, the respective edge being formed between two adjacent side faces in each case. A base body designed as a square screw nut has correspondingly four such side faces and four edges.

Advantageously, all components of the sensor module, for example with the exception of the at least one deformation detection sensor or the plurality of deformation detection sensors and/or one or more further sensors and electrical connection lines between the printed circuit board and the at least one or the respective deformation detection sensor and/or between the printed circuit board and the respective further sensor are arranged, in particular mounted, in particular fastened, on the ring-shaped printed circuit board and thus together with the printed circuit board on the end face of the base body in particular on the end face, and the entire sensor module has the feed-through opening, the arrangement on the base body being designed in such a way that the feed-through of the screw, the threaded bolt or the threaded rod through the sensor module is made possible. If the sensor module has a protective cover, this advantageously applies to the sensor module including the protective cover.

The at least one deformation detection sensor is advantageously configured as a sensor for detecting strains, compressions and/or shear forces, in particular as a strain sensor, in particular as a strain gauge sensor.

As already mentioned above, the sensor module, in particular its RFID transponder unit, can in a possible embodiment have an energy storage device, in particular a capacitor, which enables at least short-term storage of electrical energy transmitted to the RFID transponder unit by means of an RFID reader unit, in order to thereby be able to determine the pretensioning force by means of the sensor module, for example, even if no energy is transmitted to the RFID transponder unit by means of the RFID reader.

The antenna is advantageously arranged or formed as a coil on the printed circuit board. For example, it is formed as a printed coil on the printed circuit board or arranged as a wound coil on the printed circuit board. The antenna is thus advantageously formed as a coil which is, for example, printed on the printed circuit board or wound and arranged on the printed circuit board. In particular, the coil has several coil turns, but in one possible embodiment it can also have only one coil turn. Advantageously, the antenna extends over an entire circumference of the printed circuit board. This enables the sensor module to be read by means of the RFID reader at all circumferential positions of the screw nut.

In one possible embodiment, the sensor module comprises several deformation detection sensors, for example two or more than two deformation detection sensors. Advantageously, these deformation detection sensors are then evenly distributed around an outer circumference on the base body of the screw nut.

Advantageously, the screw nut comprises a protective cover for the sensor module.

An assembly device according to the invention comprises such a screw nut and a wrench.

For example, the mounting device comprises an RFID reader which is fixedly connected to the wrench or is detachably connectable or connected to the wrench.

Advantageously, a screw nut receptacle of the wrench is formed to correspond to the screw nut. For example, the screw nut receptacle of the wrench has at least one recess for receiving the at least one deformation detection sensor of the screw nut. Advantageously, this at least one recess is formed to correspond to a region of the at least one deformation detection sensor projecting beyond a surface of the base body of the screw nut.

In particular, the screw nut enables strain measurement on the screw nut, i.e. on its base body. For this purpose, the at least one deformation detection sensor, in particular strain gauge sensor, is advantageously arranged together with an analog-to-digital converter unit and the RFID transponder unit, which enables contactless electromagnetic coupling of the sensor module, in particular by means of an RFID reader, for energy and data transmission, on the base body of the screw nut, wherein the printed circuit board, which simultaneously realizes circuit, antenna and sensor contact and is expediently designed in such a way that furthermore a wrench can be used and advantageously the screw or the threaded bolt can be passed through, is arranged on its end face, i.e. in particular on an end face of the base body.

The detection of the deformation, in particular of the strain (or compression, since this is a negative strain), is advantageously carried out by means of the at least one deformation detection sensor on the outer circumferential side of the base body of the screw nut or at least in the region of the outer circumferential side, for which purpose the at least one deformation detection sensor is arranged accordingly, as described above. In particular, a deformation, in particular strain and/or compression, i.e. negative strain, in the axial direction of the screw nut, i.e. in the screwing direction of the screw nut and thus of the screw connection to be produced or having been produced, is detected. Advantageously, the sensor module, as described above, comprises a plurality of such deformation detection sensors, so that a corresponding deformation detection is made possible at a plurality of measuring points on the base body of the screw nut. In an advantageous embodiment, the at least one or the respective deformation detection sensor is arranged in a cavity formed in the base body of the screw nut, as mentioned above. As a result, the deformation detection sensor advantageously closes flush with an adjacent outer surface of the base body.

The solution according to the invention enables, in particular, fast, simple, reliable and inexpensive determination of the pretensioning force in screw connections. Advantageously, this solution according to the invention requires as few as possible or no mechanical changes to be made to the components used for the screw connection, for example to a bolt, washer and, advantageously, also to the base body of the screw nut. This means that existing standards and approvals for these components continue to be complied with. In the solution described above, this is advantageously the case at least for those embodiments of the screw nut in which no cavity or axial bore is formed in the base body of the screw nut for the at least one or the respective deformation detection sensor, because in these embodiments all components of the sensor module are attached to the surface of the base body. The base body of the screw nut advantageously corresponds to the conventional, for example standardized and/or approved, screw nut. Advantageously, no mechanical changes are made to this base body, but the sensor module is merely attached to this base body, i.e. to the conventional screw nut.

The measurement, i.e. the deformation detection on the base body of the screw nut, is advantageously carried out, as already mentioned above, by means of a deformation detection sensor designed, for example, as a strain or force sensor and without an electrical contact on the screw nut, i.e. by means of a wireless data transmission and in particular also by means of a wireless electrical energy transmission between the screw nut, in particular its sensor module, and the RFID reader. Attaching the sensor module to the base body of the screw nut greatly simplifies the performance of such measurements, since screw nuts are standardized and easily interchangeable and have a much smaller variety than, for example, screws.

To avoid possible influences on the strength of the screw connection, a size of the sensor module is advantageously miniaturized, at least to the greatest possible extent. Very advantageous for this purpose is the design of the at least one or the respective deformation detection sensor as a strain gauge sensor, also referred to in short as a strain gauge sensor. As already described above, by means of the at least one deformation detection sensor, in particular strain gauge sensor, the strain (also negative strain, i.e. compression) of the base body of the screw nut is advantageously detected on a side surface or, in the case of a plurality of such deformation detection sensors, on a plurality of side surfaces of the base body of the screw nut, which is correlated with a pretensioning force applied in the screw connection.

For the realization of the contactless detection of the strain, RFID technology is advantageously used for energy and data transmission, as already described. This means that no additional electrical energy source, in particular no battery, is required for the electrical energy supply, so that the entire sensor module can be attached to the base body of the screw nut in a miniaturized and robust design and used together with it as one component in a respective application in a very flexible manner

For example, a standard mobile RFID reader can be used to read the pretensioning force applied in the screw connection. The advantageous design of the sensor module, in particular the antenna which advantageously extends over the entire circumference of the printed circuit board, which is in particular annular in shape, makes it possible to read out measured values which have been determined and in particular already digitized in the sensor module quickly, ergonomically and reliably, regardless of the direction and thus independent of the angle of rotation of the screw nut.

The screw nut described here, in particular with the sensor module described here, thus enables reliable and ergonomic measurement of the pretensioning force both during an installation of the screw connection and, for example, during subsequent cyclical checks during an entire life cycle of the screw connection, in particular due to the fact that the sensor module operates passively, i.e. does not require a battery and is supplied with electrical energy via the external RFID reader.

The solution described here has significant advantages over other possible solutions for determining the pretensioning force of a screw connection. The pretensioning force is the quality-determining parameter for any screw connection, so its measurement is required for many applications. A measurement of a torque by means of a torque wrench represents the state of the art technology used in daily practice today. However, the measured values obtained with this method are strongly dependent on existing friction conditions, so that there is not always a clear correlation between the measured torque and the pretensioning force applied in the screw connection. With the solution described here, such measurement inaccuracies are avoided, since the values of the pretensioning force determined here are independent of the friction situation, because by means of the solution described here, the deformation, in particular in the axial direction of the base body of the screw nut, is advantageously determined, in particular a strain and/or compression, i.e. negative strain.

In the solution described here, the determination of the pretensioning force applied in the screw connection is advantageously carried out on at least one side surface or, in the case of a plurality of deformation detection sensors, correspondingly on a plurality of side surfaces of the base body of the screw nut by means of one or more deformation detection sensors designed in particular as strain sensors.

The base body of the screw nut is advantageously made of metal, since the measurement of the pretensioning force is particularly important for screw connections with metal screw nuts. However, the solution described is equally suitable for screw nuts whose base body is made of another material, for example plastic or ceramic.

When the screw connection is tightened, mechanical stresses are built up in the base body of the screw nut, which are directly correlated with the applied pretensioning force and can be registered on the respective side surface of the base body as a strain (or compression as a negative strain).

For reasons of symmetry, the respective deformation detection sensor is advantageously positioned centrically or as centrically as possible on the side surface of the base body of the screw nut. Since under real conditions of use, due to unevenness on the components involved, an inclined assembly and/or impurities, tightening of the screw connection usually does not take place in exactly the same way and thus does not lead to a rotationally symmetrical distribution of the forces, at least two deformation detection sensors, in particular in the form of strain gauge sensors, are advantageously provided in order to increase the measurement accuracy, which sensors are arranged, for example, on two opposite side surfaces of the base body of the screw nut or are arranged in a respective cavity in the respective side surface or are arranged in opposite axial bores. Advantageously, a compensation and/or evaluation of the respective measured values of these deformation detection sensors is then provided, for example by means of a suitable evaluation algorithm, for example by simple addition or formation of an average value.

As a deformation detection sensor, in particular a strain gauge sensor, all sensor types commonly used for mounting on metal for measuring strain, compression and shear forces can advantageously be used, in particular in the case of a base body of the screw nut made of metal. For example, the at least one or the respective deformation detection sensor is formed as a metal strain gauge resistor on foil, as a semiconductor strain gauge resistor or as a piezoresistive strain gauge.

A mounting of the deformation detection sensor on the side surface of the base body of the screw nut or the mounting of the respective deformation detection sensor on the respective side surface of the base body of the screw nut is advantageously performed by bonding, for example with an acrylate or with an epoxy resin, by spot welding or by glazing.

In one possible embodiment, the deformation detection sensor or the respective deformation detection sensor, in particular strain gauge sensor, is designed as a single sensor element which is mounted in such a way that a force is measured in the axial direction of the screw nut, i.e. in the direction of its longitudinal axis, in particular its axis of rotation, about which it is rotated to produce the screw connection.

However, strain gauge sensors are usually very low resistance (<=1 kΩ) and provide only a very small measurement signal (<1 mV), which is often also temperature-dependent. For this reason, in an advantageous embodiment, it is provided that the single sensor element in the deformation detection sensor or in the respective deformation detection sensor is operated together with at least one reference fixed resistor as a half bridge or as a full bridge.

In another possible embodiment, it is provided that the several deformation detection sensors of the screw nut, each designed as a strain gauge sensor, in particular as a single sensor element, are connected to form a measuring bridge. This can simplify the evaluation of the recorded measured values.

In another possible embodiment, the at least one or the respective deformation detection sensor, in particular strain gauge sensor, has several sensor elements which are connected in the form of a half bridge or full bridge and/or have temperature compensation. This is particularly advantageous for screw nuts, especially base bodies, with a large size.

In a possible further embodiment, the at least one or the respective deformation detection sensor is designed, for example, as a more complex strain gauge sensor, in particular as a so-called rosette strain gauge. However, this requires multi-channel measurement electronics.

As already described above, the readout of the measured values detected by means of the at least one deformation detection sensor or the measured values detected by means of the multiple deformation detection sensors is carried out using RFID technology, i.e. by means of an RFID¬ reader and by means of the RFID transponder unit of the sensor module, in particular in a contactless and wireless way and without using a battery in the sensor module. The RFID reader and the RFID transponder unit operate in the HF range or UHF range, for example. The electrical power supply to the sensor module is provided by the electromagnetic field emitted by the RFID reader. Bidirectional data transmission between the RFID reader and the sensor module, in particular its RFID transponder unit, also takes place via the same electromagnetic field, as is usual with RFID technology.

The sensor module, in particular its RFID transponder unit, advantageously comprises a so-called power management, i.e. an energy management unit. It includes, for example, voltage stabilization, filtering, voltage monitoring, and optionally the aforementioned energy storage unit, in particular in the form of a capacitor, which ensures the electrical power supply for a predetermined minimum time when the electromagnetic field of the RFID reader is switched off, for example in order to improve a signal-to-noise ratio by this switching off, so that it is also possible to carry out the determination of the pretensioning force in this case.

For a measurement of the voltage of the at least one deformation detection sensor, in particular designed as a strain gauge sensor, or of the multiple deformation detection sensors, an analog-to-digital converter is advantageously provided, which, in particular in the case of multiple deformation detection sensors, advantageously has multiple signal inputs. Alternatively, a separate analog-to-digital converter can be provided for each deformation detection sensor, in which case the analog-to-digital converters are advantageously positioned as close as possible to the respective deformation detection sensor in order to improve interference immunity.

As already mentioned above, the printed circuit board of the sensor module is advantageously formed. It advantageously has a, at least approximately, circular or elliptical contour or a contour comprising a hexagonal outer contour. Advantageously, all electronic components of the sensor module are arranged on the printed circuit board, of course with the exception of the at least one or the respective deformation detection sensor. A material of the printed circuit board is, for example, FR4 or a similar material. The printed circuit board comprises, for example, a plurality of layers, for example, two to six layers. A thickness of the printed circuit board is, for example, about 1.0 mm. Alternatively, it is possible for the printed circuit board to use, for example, a polymer film. Advantageously, the printed circuit board is arranged on the end face of the base body of the screw nut opposite to an action of force. Advantageously, it is firmly connected to the base body of the screw nut. It is advantageously positioned coaxially with the base body of the screw nut. The arrangement of the printed circuit board on the side opposite the force action means in particular that, in the case of the screw nut described here, it is intended to arrange it in the screw connection in such a way that the printed circuit board is positioned on the side opposite the force action. This prevents the sensor module from being destroyed by the force exerted by the screw connection.

The size of the feed-through opening in the ring-shaped printed circuit board is, as already mentioned above, suitably dimensioned so that the screw or threaded rod or threaded bolt used for the screw connection can be safely inserted through this feed-through opening.

Due to a required installation space for the printed circuit board, the described solution is particularly suitable for screw nuts, i.e. for base bodies of screw nuts, larger than or equal to M10. To miniaturize the size and increase robustness, all components on the printed circuit board are advantageously assembled on one side and by means of SMD (surface mounted device) and/or flipchip assembly and/or COB assembly (chip-on-board technology). A position of the electronic components on the ring-shaped printed circuit board is relatively freely selectable. Therefore, this position of the electronic components on the printed circuit board is advantageously optimized with regard to interference immunity and/or manufacturing costs.

In addition, this ring-shaped printed circuit board serves as a carrier for the antenna for electromagnetic coupling with the RFID reader. The antenna is advantageously designed on the printed circuit board as a coil, in particular as a printed coil (printed antenna). A number of turns of this coil, i.e. of the antenna, is essentially dependent on the RFID carrier frequency used in each case and the size of the base body of the screw nut. In particular, the number of turns is determined by an inductance required for resonance. For example, a number of turns of 2 to 20 is reasonable for high frequency transponders. For example, the number of turns is ten turns or about ten turns.

Furthermore, the printed circuit board is used for electrical contacting of the at least one or the respective deformation detection sensor, advantageously arranged on the side surface of the base body of the screw nut, in particular designed as a strain gauge sensor, for example by means of soldering, bonding or wire bonding. Electrical conductor paths between the at least one deformation detection sensor or the plurality of deformation detection sensors and the analog-to-digital converter or the plurality of analog-to-digital converters are advantageously designed to be as short as possible in order to improve interference immunity, advantageously run parallel and are advantageously designed to be shielded by copper planes located above and below them in the printed circuit board. The described multiple function of the printed circuit board leads to a considerable reduction in the size and cost of the sensor module and thus of the screw nut described here.

The screw nut described here is thus designed as a measuring nut, which advantageously consists of the base body, which forms the actual, advantageously conventional, screw nut, and the sensor module. The sensor module advantageously consists of the at least one deformation detection sensor, advantageously designed as a strain gauge sensor, or a plurality of such deformation detection sensors, in particular mounted on a side surface or in each case on a side surface of the base body of the screw nut, the printed circuit board and advantageously a protective sheath, i.e. the protective cover, around the sensor module, in particular around the at least one deformation detection sensor or around the plurality of deformation detection sensors and around the printed circuit board, in particular also around the components arranged thereon. The entire structure of the screw nut described here is advantageously implemented in a monolithic design in order to obtain, as a result, a robust, flexibly usable and contactlessly operating measuring means for the application of pretension measurement in screw connections.

The screw nut described herein is advantageously suitable as an object for tightening screwed connections in the same way as a standard screw nut without any fundamental loss of stability, since, at least in some advantageous embodiments, an original screw nut is advantageously used as the base body without any changes to its structure, advantageously at least in the embodiments that do not have a cavity or axial bore for the respective deformation detection sensor.

The described embodiment as an annular printed circuit board with a printed annular antenna, which covers the screw opening of the base body of the screw nut and, when the screw nut is screwed onto the screw or threaded rod or threaded bolt, also covers this screw or threaded rod or threaded bolt when it protrudes through the screw opening, leads to an at least approximately rotationally symmetrical structure, in particular with respect to the antenna, so that the sensor module and thus the screw nut described here, which forms the measuring nut, can be read out without contact and independently of direction. This avoids readout only from one preferred direction. This property is of particular importance for the application of the screw nut for measuring the pretensioning force, since when the screw connection is tightened it is not possible to predict at which angle of rotation the required pretensioning force is achieved and at which angle the sensor readings can therefore be read out. This independence of direction thus makes it considerably easier to use the screw nut described here to measure the pretensioning force.

For tightening the screw connection, in particular the screw nut, open-end wrenches, ring wrenches or similar tools are usually used, which must be brought into contact with the screw nut for this purpose and produce a considerable force effect on the screw nut for tightening. Therefore, in order to further enable a practicable and safe use of these tools, the at least one or the respective deformation detection sensor is mounted on the base body at a suitable position and with as low a height as possible, and advantageously the protective sheath, i.e. the protective cover, is provided for its protection, for example in the form of a potting layer or a housing, so that the at least one or the respective deformation detection sensor is protected from possible stresses or damage caused by these tools.

As already described, in the assembly device comprising the screw nut and wrench or other suitable tool, it may be provided that the shape of the tool to be used, in particular the wrench, is suitably modified to ensure easy handling and to avoid possible damage. This modification may consist, for example, in one or more protrusions in rear jaws of the wrench. The screw nut receptacle of the wrench thus advantageously has at least one recess for receiving the at least one deformation detection sensor of the screw nut, this at least one recess being formed to correspond to the region of the at least one deformation detection sensor projecting beyond the surface of the base body of the screw nut. This also allows, for example, safe use of an open-end wrench even with two deformation detection sensors mounted opposite each other on the base body.

Advantageously, the printed circuit board including the protective cover, for example in the form of a housing or a protective sheath, for example in the form of a potting, does not project beyond a contour of the base body, in the case of a hexagon screw nut beyond the hexagonal contour, in the region of the at least one or the respective deformation detection sensor at least no further than this deformation detection sensor or the respective deformation detection sensor projects beyond the contour. This also avoids possible damage caused by a wrench being used.

An overall height of the, in particular sheathed, printed circuit board is as low as possible, for example it is in the range of a few millimeters, for example in the range of 1 mm to 10 mm. Due to the described design, a good overall protection of the sensor module including the at least one deformation detection sensor, in particular designed as a strain gauge sensor, or including the respective such deformation detection sensor against damage during handling, in particular during a tightening or unscrewing of the screw nut, with the wrench is achieved.

Advantageously, the assembly of the screw nut described herein thus does not differ significantly with respect to the tool and effort to be used compared to the assembly of a comparable conventional screw nut without sensor module. The assembly is thus still very simple, reliable and inexpensive, for example with a wrench.

As mentioned above, in one possible embodiment, it may be provided that the at least one deformation detection sensor is arranged in a cavity formed in a side surface of the base body, or the respective deformation detection sensor is arranged in a respective cavity formed in a respective side surface of the base body. The cavity or the respective cavity is thus a recess in the side surface of the base body of the screw nut. This provides further improved protection of the at least one or the respective deformation detection sensor.

The cavity or the respective cavity is thereby advantageously formed up to the printed circuit board in order to also protect supply lines to the deformation detection sensor or to the respective deformation detection sensor, i.e. connecting lines between the printed circuit board and the at least one or the respective deformation detection sensor.

The cavity or the respective cavity is advantageously formed, in particular formed deep into the base body, in such a way that the at least one or the respective deformation detection sensor including the feed lines is installed flush in the side surface or in the respective side surface of the base body of the screw nut. In this way, damage by the wrench can be ruled out or at least virtually ruled out, for example even if a normal wrench is used that does not have a special recess for receiving the at least one or the respective deformation detection sensor.

As mentioned above, in one possible embodiment of the assembly device, it is provided that an RFID reader is fixedly connected to the wrench or is detachably connectable or connected to the wrench. This makes it possible to continuously determine and display the pretensioning force even while the screw nut is being tightened. The RFID reader has, for example, a display unit, in particular a display, for displaying the measured value of the determined pretensioning force. Alternatively or additionally, it can be provided, for example, that the determined measured values for the pretensioning force are transmitted via a line or wirelessly, for example via Bluetooth or other wireless communication technologies, to a further device, for example a cell phone, in particular a smartphone, and/or to a portable computer, in particular a tablet or notebook, and displayed and/or stored there. In this case, the RFID reader has a corresponding wired or wireless data transmission interface. Alternatively or additionally, for example, the RFID reader may also have a memory for storing the determined measured values of the pretensioning force.

A significant advantage of determining the pretensioning force of the screw connection on the screw nut, which is made possible with the screw nut described here, is that the conventional screw nut and thus also the base body of the screw nut described here is advantageously a low-cost component that is offered in standardized sizes and designs, and that a product variability is significantly lower compared to screws. Thus, for example, conventional screw nuts can be used as the base body for the screw nut described here, which is designed as a sensor nut and which is then provided with the sensor module, in particular with one or more deformation detection sensors designed in particular as a strain gauge sensor, in accordance with the design described here. This enables cost-effective production in larger series, in particular compared to screws or even special screws.

Compared to other possible solutions, the determination of the pretensioning force acting in a screw connection with a screw nut provided with the sensor module described here permits effective mass production, stock-keeping and marketing of this screw nut designed as a sensor nut, in particular with regard to standardized screw nuts.

In addition, a replacement of the screw nut, for example in case of a failure and/or for carrying out a recalibration of the at least one or the respective deformation detection sensor, is much easier possible than a replacement of other components of the screw connection, for example the screw or the threaded bolt, from which the arrangement of such sensors would also be conceivable.

In a possible embodiment, it is provided that the sensor module, in addition to the at least one deformation detection sensor or the plurality of deformation detection sensors, in particular designed as a strain gauge sensor, has one or more further sensors. This/these further sensor(s) is/are then, as a component of the sensor module, also operated and read out by means of the RFID technology, in an analogous manner to the at least one or the respective deformation detection sensor.

For example, one or more temperature sensor(s) is/are arranged on the printed circuit board of the sensor module and/or in the area, in particular in the immediate vicinity, of the at least one or the respective deformation detection sensor. A temperature determined with this temperature sensor or with the respective temperature sensor can then be used, for example, for a temperature compensation of the signals measured with the at least one or the respective deformation detection sensor.

Alternatively or additionally, the sensor module may comprise, for example, one or more three-dimensional acceleration sensors, in particular MEMS-based acceleration sensors. The at least one or the respective acceleration sensor is advantageously arranged on the printed circuit board, in particular on the FR4 printed circuit board, and can detect in particular, even slight, changes in position of the sensor module and thus of the measurement object, in particular of the screw nut. This information can be particularly relevant in the case of movable measurement objects, which is indeed the case with screw nuts. Alternatively or additionally, such sensors, in particular MEMS sensors, also permit, for example, a determination of accelerations and/or vibrations. Alternatively or additionally, for example, such a sensor, in particular MEMS sensor, can also be provided with at least one additional sensor for determining an angular velocity and/or magnetic field strength, in particular also the earth's magnetic field.

Since larger metal surfaces in the immediate vicinity of a coil generally lead to an influence on this coil with regard to its inductance and its quality, this also applies to the antenna, which is advantageously designed as a coil, in particular a printed coil, on the printed circuit board of the sensor module. Since this antenna is intended and used for coupling with the RFID reader, it forms a parallel resonant circuit together with a capacitor. If the screw or threaded bolt and, for example, a washer used are formed from metal, the resonant frequency of the resonant circuit is detuned by this metal, in particular due to eddy current losses occurring therein as well as any permeable materials used, for example steel, and the quality of the resonant circuit is significantly reduced. This leads to a negative influence on the energy and data transmission via the RFID coupling of the sensor module, in particular the RFID transponder unit, with the RFID reader. The occurring detuning of the resonant frequency can be corrected by an appropriate adjustment. To avoid excessive reduction of the quality of the resonant circuit by the metal and thus of the maximum possible reading distance for the RFID reader, a predetermined minimum distance of the coil forming the antenna on the printed circuit board from the base body of the screw nut and from its internal thread is advantageously provided. This minimum distance is 1 mm, for example. I.e. the antenna of the sensor module, in particular of the RFID transponder unit, advantageously has a minimum distance of 1 mm to the base body and/or to its screw opening, in particular to the thread in the screw opening. The antenna is thus designed and arranged accordingly. In particular, the antenna is appropriately formed and arranged on the printed circuit board and the printed circuit board is appropriately arranged on the base body to ensure this.

The antenna on the printed circuit board of the sensor module, in particular the antenna formed as a coil, in particular its design, is thus advantageously configured in such a way that the turns of the coil on the ring-shaped printed circuit board are advantageously located as far out as possible and are, if possible, advantageously arranged on a layer of the printed circuit board, also referred to as the layer, which is located furthest away from the base body, i.e. has the greatest distance from the base body. It is also possible for the windings to be arranged on a layer positioned, for example, next below the layer furthest away, for example if coils with many windings are used. Furthermore, it is possible that windings are arranged on several layers of the printed circuit board.

In one possible embodiment, it may be provided, for example, that the distance between the printed circuit board and the base body of the screw nut, which is formed in particular from metal, is increased by a non-electrically conductive layer lying therebetween. That is, in this embodiment, such a non-electrically conductive, in particular electrically insulating, layer is arranged between the printed circuit board and the base body. Alternatively, this layer between the printed circuit board and the base body of the screw nut is formed, for example, from a permeable material which can produce an effective reduction in the eddy currents induced in the metal by distorting the field lines. The permeable material used for this layer is advantageously selected so that it does not exhibit excessive losses even at a frequency of 13.56 MHz (the preferred frequency used by the RFID transponder unit and the RFID reader). This material can be produced, for example, by mixing an appropriately suitable ferrite powder into a flexible plastic.

The use of RFID technology offers significant further advantages in addition to the realization of the determination function described, particularly with regard to the pretensioning force. In particular, the use of a non-volatile data memory of the RFID transponder unit for storage of information such as, for example, identification number, calibration data of the sensors of the sensor module, manufacturer and type information of the screw nut designed as a sensor nut and/or usage data is very advantageously possible. In principle, RFID technology also offers the possibility of parallel measurement and reading of several screw nuts formed as sensor nuts in the manner described above, which are located on the same side in the electromagnetic field of the RFID reader, by means of typically implemented anti-collision algorithms If the special version of NFC (Near Field Communication) is used as the RFID technology, the measurement data determined can also be read, for example, with a cell phone, in particular a smartphone with an NFC interface or with other devices with an NFC interface, and can be displayed and processed particularly easily when transmitted, for example as an NDEF message. In one possible embodiment, the RFID transponder unit of the sensor module is thus designed as an NFC transponder unit and the RFID reader is designed as an NFC reader, for example as a cell phone, in particular smartphone, or as a portable computer, for example tablet or notebook, with an NFC interface.

In one possible embodiment, it may be provided, for example, that the base body of the screw nut is longer, i.e. larger, in the axial direction than a comparable standardized screw nut. This improves the measurement accuracy with respect to the pretensioning force. The height of standardized conventional hexagon screw nuts, i.e. their size in the axial direction, is usually about half the width across flats. The width across flats refers to the wrench intended for use with the screw nut. In the embodiment described here, the base body is thus advantageously larger in the axial direction, i.e. with respect to its height, i.e. larger than half the width across flats, in particular substantially larger. For example, this height of the base body corresponds to at least two thirds or three quarters or four fifths of the width across flats or to at least the width across flats.

In a possible embodiment, it can be provided that an additional marking of the associated screw/threaded bolt and/or the screwed components of the screw connection with a transponder and/or with a matrix or bar code is provided in order to identify the measuring point at which the screw nut is located. This avoids, for example, that there is no assignment to the location of the measurement of the pretensioning force when the screw nut is replaced. The measured values determined by the screw nut designed as a sensor nut are advantageously stored linked to an ID number of the screw nut, which is advantageously stored in its RFID transponder unit. If the above-described marking of the measuring point is provided, it is thus possible to additionally link these measured values also with this marking of the measuring point, i.e. with a corresponding identification information of the measuring point, and to store this together. This enables unambiguous assignment of the determined measured values, in particular with regard to the pretensioning force, to the screw nut and to the measuring point.

As already mentioned above, in one possible embodiment it can be provided that the at least one or the respective deformation detection sensor is arranged in an axial bore in the area of an edge between two adjacent side surfaces in the base body. This is another possibility for the, in particular protected, arrangement of the at least one or respective deformation detection sensor. Furthermore, this enables a particularly good coupling with the base body for detecting its deformation corresponding to the pretensioning force.

In a possible embodiment, it may be provided that the entire sensor module, i.e. including the printed circuit board with antenna and RFID transponder unit and of course including the at least one deformation detection sensor, is arranged on a side surface of the base body of the screw nut. Although this enables measurement and, in particular, readout by means of the RFID reader at only one point, and furthermore the determination of the pretensioning force is thus less accurate and a lateral overall height of the screw nut in the area of the sensor module is greater, this embodiment is particularly cost-effective. In particular, due to the greater lateral overall height, i.e. the greater extension in the radial direction of the screw nut in the region of the sensor module, this embodiment is advantageously suitable for larger base bodies, for example from dimension M18 upwards.

As an alternative to the screw nut described above, it can also be provided, for example, that the sensor module described above and used there for the screw nut is arranged on a screw head of a screw. Thus, a sensor screw is formed, comprising a screw base body and the sensor module. The at least one or the respective deformation detection sensor is then arranged on the screw head, in particular at a respective suitable location and with suitable orientation, or on a respective side surface of the screw head, in the same way as in the case of the screw nut described above. Alternatively, the deformation detection sensor can, for example, be arranged rotationally symmetrically on the bolt head, whereby this deformation detection sensor then integrates advantageously through its structure via asymmetrically applied forces. This means that only one deformation detection sensor, in particular a strain gauge sensor, is required.

Examples of embodiments of the invention are explained in more detail below with reference to drawings.

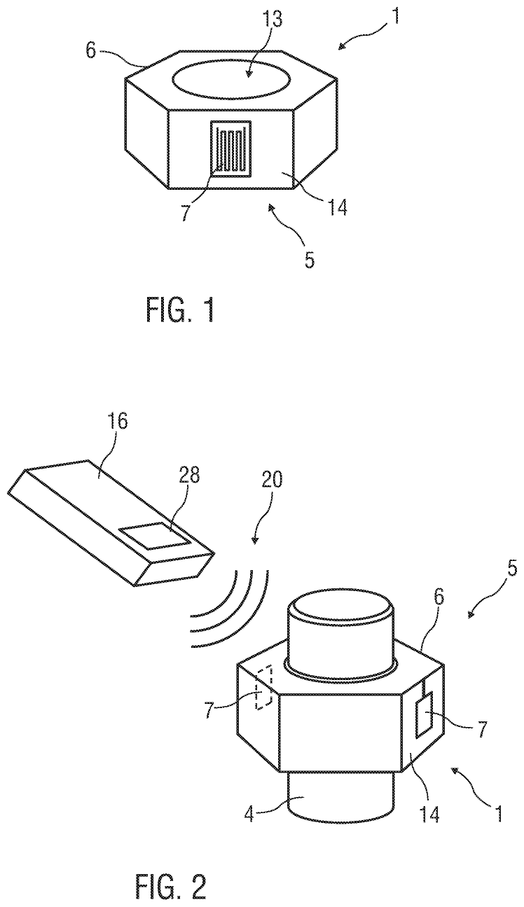

FIG. 1 schematically shows a perspective view of an embodiment of a screw nut,

FIG. 2 schematically shows a determination of a pretensioning force of a screw connection,

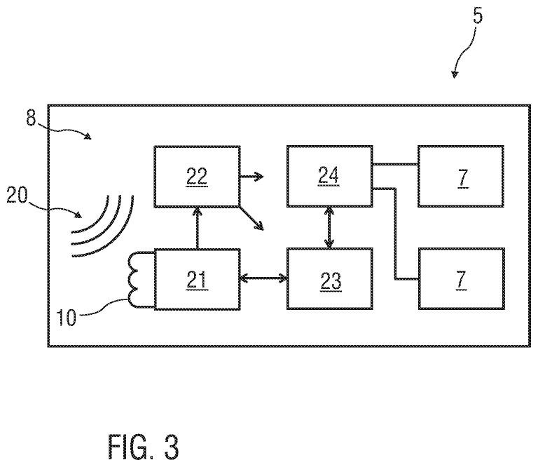

FIG. 3 schematically shows a sensor module,

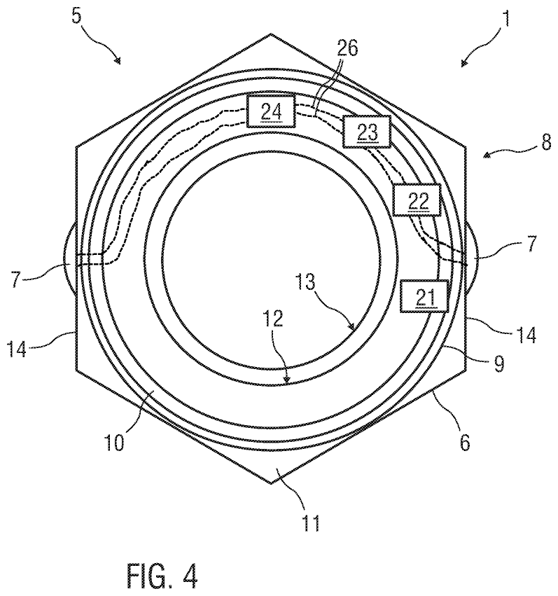

FIG. 4 schematically shows a top view of an end face of an embodiment of a screw nut,

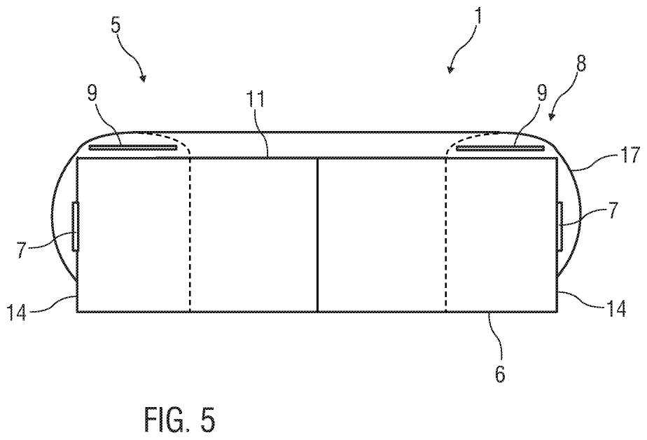

FIG. 5 schematically shows a side view of an embodiment of a screw nut with a sensor module of the screw nut shown in section,

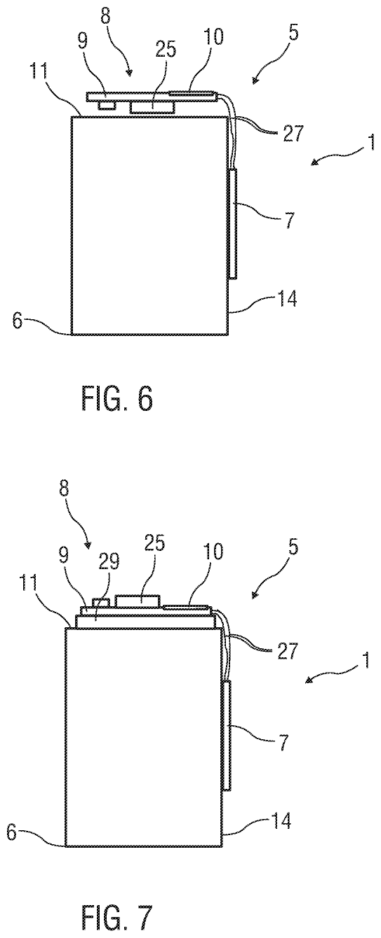

FIG. 6 schematically shows a part of a longitudinal sectional view of an embodiment of a screw nut,

FIG. 7 schematically shows a part of a longitudinal sectional view of a further embodiment of a screw nut,

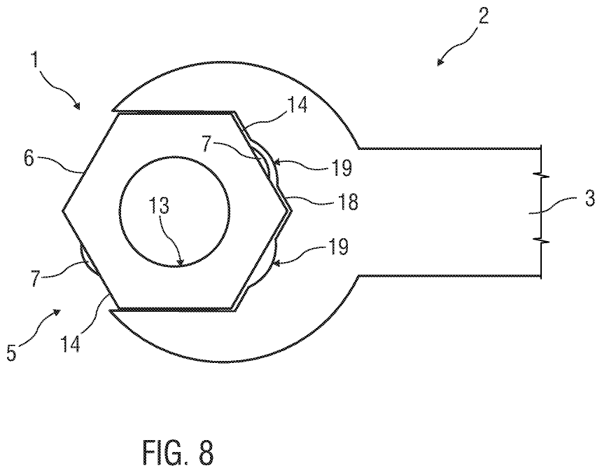

FIG. 8 schematically shows an assembly device,

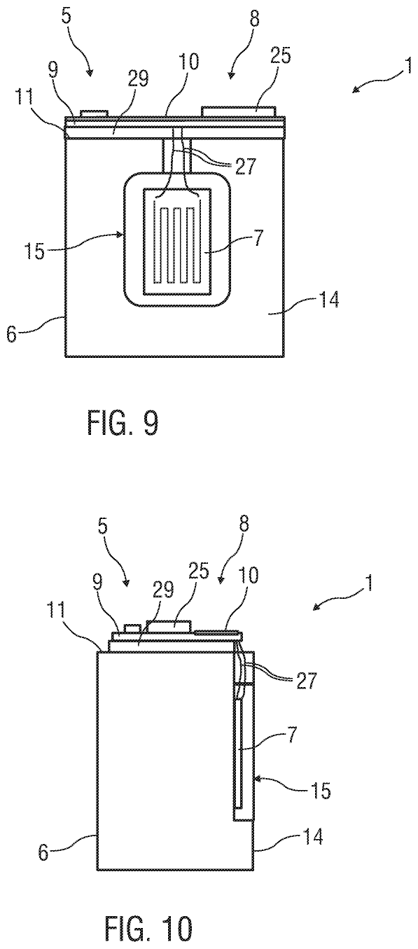

FIG. 9 schematically shows a part of a side view of an embodiment of a screw nut, and

FIG. 10 schematically shows a part of a longitudinal sectional view of the embodiment of the screw nut according to FIG. 9.

Corresponding parts are marked with the same reference signs in all figures.

With reference to FIGS. 1 to 10, a screw nut 1 and an assembly device 2 with such a screw nut 1 and a wrench 3 are described below. The screw nut 1 can be used to make a screw connection by screwing this screw nut 1, in particular by means of the wrench 3, for example onto a screw 4, onto a threaded rod or onto a threaded bolt.

In all embodiments shown, the screw nut 1 comprises a sensor module 5 for determining a pretensioning force of the screw connection. The screw nut 1 described here is thus designed as a sensor nut, which comprises a base body 6 as the actual screw nut and additionally the sensor module 5, which is arranged on this base body 6.

The sensor module 5 comprises at least one deformation detection sensor 7 arranged on the base body 6 of the screw nut 1 for detecting a deformation of the base body 6 of the screw nut 1 or a plurality of such deformation detection sensors 7, in the exemplary embodiments shown here advantageously two such deformation detection sensors 7 each, and an RFID transponder unit 8. A printed circuit board 9 of the sensor module 5, on which an antenna 10 of the RFID transponder unit 8 and an electronic circuit of the sensor module 5 are formed and on which advantageously the entire RFID transponder unit 8 is arranged, and which is electrically conductively coupled to the respective deformation detection sensor 7, is arranged on an end face 11 of the base body 6, in particular on the end face 11, in particular on a surface of this end face 11, advantageously only on the surface of this end face 11, in particular not projecting beyond this surface inwards, in the direction of a screw opening 13 of the base body 6. In this case, it can rest directly on the end face 11 or be spaced therefrom, but advantageously is always attached to the end face 11, i.e. in particular connected to the end face 11.

The screw nut 1 described here in the form of a sensor nut is thus a telemetric screw nut 1, which enables contactless measurement of the pretensioning force in the screw connection to be produced or having been produced by means of the screw nut 1.

In the advantageous embodiments shown here, the printed circuit board 9 is annular in shape, in particular circular or elliptical, as can be seen in particular in FIG. 4. The ring-shaped printed circuit board can also have a hexagonal outer contour. Here, advantageously, a clear width of a feed-through opening 12 of the printed circuit board 9 and expediently also of the entire sensor module 5 is at least as large as a clear width of the screw opening 13 of the base body 6 of the screw nut 1, advantageously larger than the clear width of the screw opening 13, as shown in FIG. 4. Here, the printed circuit board 9 is formed in an annular round shape, so that a diameter of the feed-through opening 12 of the printed circuit board 9 is larger than a diameter of the screw opening 13 of the base body 6 of the screw nut 1. Advantageously, the entire sensor module 5 is also formed in accordance with the printed circuit board 9, i.e. in particular in an annular and round shape.

In the embodiments shown here, the respective deformation detection sensor 7 is arranged in the region of an outer circumferential side of the base body 6, for example on a side surface 14, as shown in FIGS. 1 and 2 and 4 to 8, or in a cavity 15 formed in a side surface 14, as shown in FIGS. 9 and 10, or in an axial bore in the region of an edge between two adjacent side surfaces 14. In the examples shown here, the base body 6 is formed as a hexagonal screw and thus has six side surfaces 14 and six edges, the respective edge being formed between two adjacent side surfaces 14.

By means of the respective deformation detection sensor 7, a strain and/or compression, i.e. a negative strain, occurring in the axial direction of the base body 6 of the screw nut 1 is advantageously determined. Such strains and/or compressions correlate with the pretensioning force when establishing the screw connection by screwing the screw nut 1 onto the screw 4, threaded rod or threaded bolt and when the screw connection has been produced, so that the pretensioning force can be determined from this strain and/or compression determined by means of the respective deformation detection sensor 7. The axial direction is the direction parallel to a rotational axis of the base body 6 of the screw nut 1, in particular parallel to a rotational axis of the screw opening 13 in the base body 6, about which the screw nut 1 is rotated to establish the screw connection and is thereby screwed onto the screw 4, threaded rod or threaded bolt. The respective deformation detection sensor 7 is thus advantageously designed accordingly and arranged on the base body 6 to make this possible.

The deformation detection sensors 7 are advantageously arranged uniformly distributed around an outer circumference of the base body 6 on the base body 6 of the screw nut 1. In the case of the two deformation detection sensors 7 shown here, these are advantageously arranged opposite each other on the base body 6, as shown in FIGS. 2, 4, 5 and 8.

The respective deformation detection sensor 7 is expediently designed as a sensor for detecting strains, compressions, i.e. negative strains, and/or shear forces, in particular as a strain sensor, in particular as a strain gauge sensor.

It may be provided, in particular in the embodiments shown here, that the RFID transponder unit 8 has an energy storage device, in particular a capacitor. This makes it possible, in particular, to store electrical energy transmitted from an RFID reader 16 to the RFID transponder unit 8, in particular to store it temporarily at least for a short time, in order to then be able to carry out a determination of the pretensioning force without a connection to the RFID reader 16, the sensor module 5 being operated with this electrical energy stored in the energy storage.

The antenna 10 of the sensor module 5, in particular of the RFID transponder unit 8, is advantageously formed as a coil, in particular as a printed coil, on the printed circuit board 9, as shown in FIG. 4.

Advantageously, the screw nut 1 comprises a protective cover 17 for the sensor module 5, as shown for example in FIG. 5.

As mentioned above, the assembly device 2 comprises the screw nut 1 and a wrench 3. It may be provided, for example, that the RFID reader 16 is fixedly connected to the wrench 3 or is detachably connectable or connected to the wrench 3. Alternatively or additionally, it can be provided, for example, that a screw nut receptacle 18 of the wrench 3 has at least one recess 19 for receiving the at least one deformation detection sensor 7 of the screw nut 1 or the respective deformation detection sensor 7 of the screw nut 1 facing the screw nut receptacle 18, as shown in FIG. 8. Advantageously, this at least one recess 19 or the respective recess 19 is formed corresponding to a region of this deformation detection sensor 7 projecting beyond a surface of the base body 6 of the screw nut 1, as shown in FIG. 8.

In the following, possible features and advantages of this screw nut 1 are described in detail, in particular with reference to the embodiments shown in FIGS. 1 to 10.

The screw nut 1 forms a device or is a component of a device, in particular together with the RFID reader 16 and, for example, with the wrench 3, whereby this device, in particular the screw nut 1, enables a method to be carried out for determining the pretensioning force in a screw connection, in particular quickly, simply, reliably and inexpensively. Advantageously, as few or no mechanical changes as possible have to be made to the components used for the screw connection, for example to the screw 4 or the threaded bolt or the threaded rod, to any washer that may be used, and advantageously also to the base body 6 of the screw nut 1. As a result, existing standards and approvals for these components can advantageously continue to be complied with.

In particular to achieve this objective, the measurement is carried out, for example, by means of strain and/or force sensors and without an external electrical contact on the screw nut 1, i.e. the respective deformation detection sensor 7 is advantageously designed as such a strain and/or force sensor.

The attachment of the sensor module 5 to the base body 6 of the screw nut 1 considerably simplifies the performance of the determination of the pretensioning force in comparison with the attachment to other components of the screw connection, since the base body 6 of the screw nut 1 is advantageously a component which is standardized and easily replaceable, screw nuts having a considerably smaller variety than screws, for example.

To avoid possible influences on the strength of the screw connection, a size of the sensor module 5 is advantageously miniaturized, at least to the greatest possible extent. Very advantageously, strain gauge sensors, hereinafter also referred to as strain gauge sensors, can be used for this purpose as deformation detection sensors 7, which determine the strain on a side surface 14 or, if several such deformation detection sensors 7 are used, preferably on several side surfaces 14 of the base body 6 of the screw nut 1, this strain being correlated with the pretensioning force applied in the screw connection.

For the realization of the contactless determination of this strain and thus of the pretensioning force, RFID technology is used in a particularly advantageous manner for energy and data transmission. This means that no additional battery is required for the electrical power supply of the sensor module 5, so that the entire sensor module 5 can be attached to the base body 6 of the screw nut 1 in a miniaturized and robust design and can be used together with it as a single component in the respective application in a very flexible manner For example, a standard mobile RFID reader 16 can be used to read the pretensioning force applied in the screw connection.

Due to the design of the sensor module 5 described and shown here, in particular due to the ring-shaped printed circuit board 9 and the antenna 10 formed thereon, it is possible to read out the digitized measured values in a direction-independent manner, in particular independently of an angle of rotation of the screw nut 1, and thus quickly, ergonomically and reliably. The screw nut 1 with the sensor module 5 described here enables reliable and ergonomic measurement of the pretensioning force both during an installation of the screw connection and during subsequent cyclical checks during the entire life cycle of the screw connection, since the sensor module 5 operates passively and does not require a battery.

In the solution described in detail below, the determination of the pretensioning force applied in the screw connection at the side surfaces 14 of the base body 6 of the screw nut 1 is carried out by means of one or more deformation detection sensors 7, in particular designed as strain sensors. In the following, it is assumed, in particular for the embodiments described here and shown in FIGS. 1 to 10, that the base body 6 of the screw nut 1 is made of metal, since the determination of the pretensioning force is of particular importance for screw connections with such nuts, although base bodies 6 made of other materials, for example plastic or ceramic, are not to be excluded. When the screw connection is tightened, mechanical stresses are built up in the screw nut 1, in particular in its base body 6, which are directly correlated with the applied pretensioning force and can be registered as a strain at the respective side surface 14.

FIG. 1 shows the proposed mounting of a strain gauge sensor as the most common version of a strain sensor and thus of a deformation detection sensor 7. Preferably, for reasons of symmetry, the deformation detection sensor 7 is positioned centrically or at least as centrically as possible on the side surface 14 of the base body 6 of the screw nut 1.

Since under real conditions of use, due to unevenness on the components involved, due to an inclined assembly and/or due to impurities, the tightening of the screw connection usually does not take place in an exactly uniform manner and thus does not lead to a rotationally symmetrical distribution of the forces, at least two such deformation detection sensors 7 are advantageously provided on the base body 6 in order to increase the measurement accuracy, which sensors are mounted, for example, on two opposite side surfaces 14 of the base body 6 of the screw nut 1, as shown in FIGS. 2, 4, 5 and 8. The respective measured values of the deformation detection sensors 7 are then advantageously compensated and evaluated by means of a suitable evaluation algorithm, for example simple addition or formation of an average value.

As a deformation detection sensor 7, in particular a strain gauge sensor, all sensor types commonly used for mounting on metal for measuring strain, compression and shear forces are applicable, e.g. metal strain gauge resistors on foil, semiconductor strain gauge resistors and piezoresistive strain gauges, especially when the base body 6 is made of metal. In this case, the mounting of the deformation detection sensors 7, in particular strain gauge sensors, on the respective side surface 14 of the base body 6 of the screw nut 1 is advantageously carried out using a mounting technology usually applied for the respective sensor type, for example bonding with an acrylate, bonding with an epoxy resin, spot welding or glazing on.

In the simplest design, strain gauge sensors with single sensor elements are used as deformation detection sensors 7, for example, which are mounted in such a way that they measure the force in the longitudinal axis of the base body 6 of the screw nut 1, i.e. in the direction of the axis of rotation of the base body 6 of the screw nut 1. The axis of rotation in this case, as already explained above, is the axis about which the screw nut 1 is rotated in order to make the screw connection.

However, strain gauge sensors usually have a very low resistance (<=1 kΩ) and also provide only a very small measurement signal (<1 mV), which is often also temperature-dependent. For this reason, the individual sensor elements are advantageously operated together with reference fixed resistors as half or full bridges. Alternatively, when several deformation detection sensors 7 designed as strain gauge sensors are mounted on the base body 6 of the screw nut 1, the individual sensor elements can also be connected to form a measuring bridge, which can simplify the evaluation. Alternatively, in particular in the case of screw nuts, in particular base bodies 6, with a large size, strain gauge sensors with several sensor elements can also be used as deformation detection sensors 7, which are connected in the form of a half or full bridge and/or have temperature compensation. Alternatively, it is also possible to use more complex strain gage sensors as deformation detection sensors 7, e.g. so-called rosette strain gages, which, however, require multi-channel measurement electronics.

The readout of the determined measured values of the at least one deformation detection sensor 7, in particular designed as a strain gauge sensor, or of the several deformation detection sensors 7, in particular designed as strain gauge sensors, is advantageously carried out using RFID technology, for example in the HF or UHF range, without contact and without the use of a battery in the sensor module 5. However, a rechargeable energy store, in particular a capacitor, can be provided, for example, as already mentioned above. Power is supplied to the sensor module 5 by an electromagnetic field 20 emitted by the RFID reader 16, as shown in FIG. 2. Bidirectional data transmission is also performed via the same electromagnetic field 20, as is common in RFID technology.

FIG. 3 shows a block diagram of a possible embodiment of the sensor module 5, which realizes the determination of the pretensioning force in the example shown with two deformation detection sensors 7, in particular in the form of a strain gauge sensor. The sensor module 5 comprises a radio front end 21, a power management, i.e. a power management unit 22, a microcontroller 23, in particular designed as a state machine, at least one analog-to-digital converter 24, also referred to as an analog-to-digital converter, and the at least one deformation detection sensor 7, advantageously several, in this case two, deformation detection sensors 7. A component of the RFID transponder unit 8 is in particular the radio front end 21, for example also the power management, for example also the microcontroller 23.

A non-volatile memory commonly used in RFID transponder units 8, for example EEPROM or FRAM, is included in the radio front end 21 and is not shown separately. The radio front end 21 is in particular a communication module of the RFID transponder unit 8, advantageously also comprising the antenna 10, via which in particular the communication with the RFID reader 16 and the reception of the electrical energy transmitted by the RFID reader 16 takes place.

The power management, i.e. the power management unit 22, includes, for example, a voltage stabilization, a filtering, a voltage monitoring and optionally the already mentioned energy storage, in particular in the form of a capacitor, which ensures the electrical energy supply for a predetermined minimum time when the electromagnetic field 20 of the RFID reader 16 is switched off, for example in order to improve a signal-to-noise ratio by this switching off, so that the determination of the pretensioning force can also be carried out in this case.

For a measurement of electrical voltages of the deformation detection sensors 7, in particular designed as strain gauge sensors, the analog-to-digital converter 24 is provided here with a plurality of signal inputs for the plurality of deformation detection sensors 7. Alternatively, a separate analog-to-digital converter 24 can also be provided for each deformation detection sensor 7, in which case the analog-to-digital converters 24 are advantageously positioned as spatially close as possible, i.e. as close as possible, to the respective deformation detection sensor 7 in order to improve interference immunity.

Advantageously, all electronic components 25 of the sensor module 5, i.e. in particular the radio front end 21, the energy management unit 22, the microcontroller 23 and/or the at least one analog¬ digital converter 24, are arranged on the ring-shaped printed circuit board 9. The printed circuit board 9 is formed, for example, from FR4 or a similar material or from polymer film, advantageously has several layers, for example two to six layers, and has, for example, a thickness of approximately 1.0 mm. The printed circuit board 9 advantageously has an, at least approximately, circular or elliptical contour or a contour comprising a hexagonal outer contour. It is expediently arranged on the end face 11 of the base body 6 of the screw nut 1 opposite the force application. Advantageously, it is firmly connected to the base body 6. Advantageously, the printed circuit board 9 is aligned coaxially with the base body 6 of the screw nut 1, as shown in FIG. 4. The arrangement of the printed circuit board 9 on the end face 11 opposite the force effect means that it is intended to mount the screw nut 1 in the screw connection in such a way that the end face 11 of the base body 6 on which the printed circuit board 9 is arranged faces away from the force effect produced by this screw connection.

The size of the feed-through opening 12 in the ring-shaped printed circuit board 9 is expediently dimensioned so that the screw 4 or threaded rod or the threaded bolt used for the screw connection can be securely inserted through in the state of the printed circuit board 9 mounted on the screw nut 1. Since this printed circuit board 9 requires a certain installation space, the base body 6 of the screw nut 1 advantageously has a certain size for the use of the sensor module 5 described, so that the application appears reasonable for screw nuts >M10, for example. This also applies to the mounting of the deformation detection sensors 7 on the side surfaces 14 of the base body 6 of the screw nut 1, which also require a certain surface area.

In order to miniaturize the size and to increase the robustness, advantageously all components 25 on the printed circuit board 9 are assembled on one side and advantageously by means of SMD and/or flip chip assembly and/or COB assembly, whereby the position of the electronic components 25 on the annular printed circuit board 9 is relatively freely selectable and thus advantageously optimized with respect to interference immunity and manufacturing costs.

In addition, this ring-shaped printed circuit board 9 advantageously serves as a carrier for the antenna 10 which realizes the electromagnetic coupling with the RFID reader 16 and which is very advantageously designed on the printed circuit board 9 as a printed coil (“printed antenna”). The number of turns of this coil is essentially dependent on the selected RFID carrier frequency and the size of the base body 6 of the screw nut 1, and is, for example, around 10 turns.

Furthermore, the printed circuit board 9 expediently serves for the electrical contacting of the deformation detection sensors 7, in particular strain gauge sensors, mounted on the side surfaces 14 of the base body 6 of the screw nut 1, for example by means of soldering, bonding or wire bonding. Electrical conductor tracks 26, in particular on the printed circuit board 9, between the deformation detection sensors 7, in particular strain gauge sensors, and the at least one analog-to-digital converter 24, as shown here, or the plurality of analog-to-digital converters 24, are advantageously designed to be as short as possible, i.e. as short as possible, and in parallel in order to improve interference immunity. In addition, they are advantageously shielded by copper planes which are arranged above and below them in the printed circuit board 9. The described multiple function of the printed circuit board 9 leads to a considerable reduction in the size and cost of the sensor module 5 and thus of the screw nut 1 designed as a sensor nut.

The screw nut 1 designed as a sensor nut thus advantageously consists of the base body 6 as the actual screw nut and the sensor module 5, which in turn advantageously consists of the at least one or more deformation detection sensors 7, in particular strain gauge sensors, in particular mounted on a respective side surface 14 of the base body 6 of the screw nut 1, the printed circuit board 9 and advantageously the protective cover 17 around the deformation detection sensors 7, in particular strain gauge sensors, and the printed circuit board 9, as shown in FIG. 5. The protective cover 17 is, for example, a sheath, a housing and/or a potting.

The entire structure of the screw nut 1 is advantageously designed as a monolithic construction, in order to obtain a robust, flexible and contactless measuring device for the application of pretension determination in screw connections. This screw nut 1, designed as a sensor nut, is advantageously suitable as an object for tightening screw connections in the same way as a standard screw nut without any fundamental loss of stability, since an original screw nut is advantageously used as the base body 6 without any changes to its structure. An exception to this is, for example, the embodiment according to FIGS. 9 and 10, i.e. the arrangement of the respective deformation detection sensor 7 in a cavity 15 in the base body 6, since here the respective cavity 15 is formed in the base body 6, for example in a conventional screw nut, and thus represents a deviation of the base body 6 from this conventional screw nut.

The described design of the printed circuit board 9 as an annular printed circuit board 9 with a printed annular antenna 10, which encloses the screw opening 13 of the base body 6 and, when the screw connection is produced or already during its production, usually also a part of the screw 4, of the threaded rod or the threaded bolt extending through the screw nut 1, advantageously leads to an at least approximately rotationally symmetrical structure with respect to the antenna 10, so that the sensor module 5 and thus the screw nut 1 designed as a sensor nut can be read out without contact and independently of direction, as shown in FIG. 2. This is a significant advantage of the solution described here. This property is of particular importance for the application of the screw nut 1 for determining the pretensioning force, since when the screw connection is tightened it is not possible to predict at which angle of rotation the required pretensioning force is achieved and at which angle the sensor readings can therefore be read out. The solution described allows this to be done at any angle of rotation of the screw nut 1. This independence of direction makes it much easier to use the screw nut 1 to determine the pretensioning force.

For tightening the screw connection, open-end wrenches or ring wrenches or similar tools are used as wrenches 3, for example, which for this purpose must be brought into contact with the screw nut 1, in particular with its base body 6, and cause a considerable force effect on the screw nut 1, in particular on its base body 6, for tightening. In order to ensure a practicable and safe use of these tools, in particular wrenches 3, the deformation detection sensors 7, in particular strain gauge sensors, are advantageously mounted on the base body 6 at a suitable position and with the lowest possible overall height. Alternatively or additionally, the deformation detection sensors 7, in particular strain gauge sensors, are advantageously protected from possible loads or damage by these tools, in particular wrenches 3, by the aforementioned protective cover 17, for example a potting layer or a housing, as shown in FIG. 5.

In a possible embodiment of the assembly device 2, it is provided that the shape of the tool to be used, in particular the wrench 3, is suitably modified, i.e. adapted to the shape, in particular peripheral shape, in particular peripheral contour, of the screw nut 1, in order to ensure easy handling and to avoid possible damage. This modification consists, for example, in the aforementioned design of the screw nut receptacle 18 with the at least one recess 19 formed corresponding to the region of the at least one deformation detection sensor 7 projecting beyond the surface of the base body 6 of the screw nut 1, or with the multiple recesses 19 for receiving the at least one deformation detection sensor 7, as shown in FIG. 8, i.e. for example in dents in rear jaws of the wrench 3. This also allows safe use of a wrench 3 designed as an open-end wrench even with two deformation detection sensors 7 arranged opposite each other on the base body 6.

Advantageously, the printed circuit board 9 including the protective cover 17, which is designed, for example, as a housing or potting, does not protrude over the contour of the base body 6 or, in the area of the deformation detection sensors 7, which are designed, in particular, as strain gauge sensors, at least does not protrude further than these over the contour of the base body 6 in order to also avoid possible damage by the wrench 3 or another tool used here.

An overall height of the printed circuit board 9, in particular sheathed in the protective cover 17, is advantageously as low as possible, i.e. as low as possible. For example, it is in the range of a few millimeters. For example, it is approximately 1 mm to 10 mm.

Due to the described design, a good overall protection of the sensor module 5 including the deformation detection sensors 7, in particular designed as strain gauge sensors, against damage during handling with the wrench 3 is achieved. In principle, the assembly of the screw nut 1 described here therefore advantageously does not differ, or at least does not differ significantly, in terms of the tools and effort to be used from an assembly of a comparable conventional screw nut without sensor module 5. The assembly is thus still carried out in a very simple, reliable and inexpensive manner, for example with a wrench 3.

Optionally, the mounting of the at least one deformation detection sensor 7 or the plurality of deformation detection sensors 7, in particular each formed as a strain gauge sensor, can be carried out in a respective cavity 15, as already described above and shown in FIGS. 9 and 10, i.e. in a recess in the respective side surface 14 of the base body 6, so that the respective deformation detection sensor 7 is even better protected. Advantageously, this cavity 15 is formed in the base body 6 up to the printed circuit board 9 in order to also protect electrical connection lines 27 of the respective deformation detection sensor 7 to the printed circuit board 9, as shown in FIGS. 9 and 10. Advantageously, the respective deformation detection sensor 7 including its connection lines 27 is flush-mounted in the respective side surface 14 of the base body 6 of the screw nut 1, so that damage to the respective deformation detection sensor 7 by the wrench 3 or another tool can, at least almost, be ruled out.

When using the screw nut 1, it is particularly advantageous if the pretensioning force can also be continuously determined and displayed during tightening. For this purpose, as already mentioned above, it is provided, for example, that, in particular in the case of the assembly device 2, the RFID reader 16 is fixedly connected to the wrench 3 or is detachably connectable or connected to the wrench 3, i.e. the wrench 3 to be used can optionally be provided with the RFID reader 16, which is fixedly or also detachably connected thereto. This RFID reader 16 can have, for example, a display unit 28, in particular a display, for displaying the measured value and/or transmitting the measured values, for example via a line and/or wirelessly, for example via Bluetooth or another wireless technology, to a further device, for example a cell phone, in particular a smartphone, or a portable computer, for example a tablet or a notebook, so that they can be displayed and/or stored there.

In addition, a significant advantage of determining the pretensioning force of the screw connection on the base body 6 of the screw nut 1, which is advantageously designed as a conventional screw nut, is that screw nuts are a low-cost component that is offered in standardized sizes and designs and whose product variability is significantly lower than that of screws. This means that screw nuts, which are used as the base body 6 for the screw nut 1 described here and are provided with deformation detection sensors 7, in particular in the form of strain gauge sensors, in accordance with the structure described here, can be manufactured more cost-effectively and in larger series than, for example, screws 4 or even special screws. Compared to other solutions offered or conceivable up to now, the determination of the pretensioning force acting in the screw connection with the screw nut 1 provided with the sensor module 5 described here permits effective mass production, storage and marketing of this screw nut 1 designed as a sensor nut for standardized nut applications. In addition, the replacement of the screw nut 1, for example in the event of a failure and/or to perform a recalibration of the respective deformation detection sensor 7 is much easier than the replacement of a screw 4 or a threaded bolt.

In addition to the use of the at least one or the respective deformation detection sensor 7, in particular strain gauge sensor for deformation measurement, in particular strain measurement, the sensor module 5 has, for example, at least one or more further sensors. This at least one further sensor or these several further sensors is/are then advantageously also operated and read out by means of RFID technology, i.e. in particular they also receive electrical energy from the RFID reader 16 via the electromagnetic field 20 and the readout of the sensor results is also carried out by means of the RFID reader 16, analogously to the respective deformation detection sensor 7.

For example, at least one temperature sensor or several temperature sensors is/are arranged as further sensors on the printed circuit board 9 of the sensor module 5 or in the area, in particular in the immediate vicinity, of the deformation detection sensors 7 or the respective deformation detection sensor 7. A temperature measured with the at least one temperature sensor can then be used, for example, for temperature compensation of the signals measured with the respective deformation detection sensor 7, which is designed in particular as a strain gauge sensor.

Alternatively or additionally, at least one three-dimensional acceleration sensor or several three-dimensional acceleration sensors based on MEMS are possible as further sensors. This is relatively easy to implement. This respective further sensor is then arranged, for example, on the printed circuit board 9, which is designed in particular as an FR4 printed circuit board, and can detect, for example, even slight changes in the position of the sensor module 5 and thus of the measured object, i.e. the screw nut 1. This information can be particularly relevant for movable measurement objects, which is what screw nuts 1 are. Alternatively or additionally, such MEMS sensors also enable measurement of accelerations and vibrations. Alternatively or additionally, for example, such a MEMS sensor can be provided with an additional sensor for measuring angular velocity or magnetic field strength, including the earth's magnetic field, on the sensor module 5.

Since larger metal surfaces in the immediate vicinity of a coil generally lead to an influence on this coil with respect to its inductance and its quality, this also concerns the antenna 10, advantageously formed as a coil, in particular as a printed coil, on the printed circuit board 9 of the sensor module 5, which is used for the coupling with the RFID reader 16 and thus, as usual, forms a parallel resonant circuit together with a capacitor. Due to the metal of, for example, a washer used in the screw connection and the metal of, in particular, the part of the screw 4 or of the threaded bolt or of the threaded rod passed through the feed-through opening 12 in the sensor module 5, the resonant frequency of the resonant circuit is detuned and the quality of the resonant circuit is substantially reduced, in particular due to eddy current losses occurring in these metals as well as permeable materials, for example steel, which may be used, which leads to a negative influence on the energy and data transmission via the RFID coupling. The occurring detuning of the resonant frequency can be corrected by an appropriate adjustment.

To avoid an excessive reduction of the quality of the resonant circuit and thus of the maximum possible reading distance with the RFID reader 16 due to the metal, a minimum distance of the antenna 10 designed as a coil on the printed circuit board 9 to the base body 6 and to the screw opening 13, in particular to the thread in the screw opening 13, is advantageously provided, which is for example in the range of approx. 1 mm. The design of the antenna 10 formed as a coil on the printed circuit board 9 of the sensor module 5 is thus such that the windings of the coil on the annular printed circuit board 9 are located as far as possible, for example as far as possible, on the outside and, moreover, are, if possible, located on at least one printed circuit board layer of the printed circuit board 9 which is located far, for example furthest, away from the base body 6, as shown in FIGS. 4, 6, 7, 9 and 10.

In possible embodiments, a non-electrically conductive, in particular electrically insulating, at least high-resistance, layer 29 is arranged between the printed circuit board 9 and the base body 6, in particular its end face 11, on which the sensor module 5 is arranged, as shown in FIGS. 7, 9 and 10. This layer 29 increases the distance between the printed circuit board 9 and the metal of the base body 6 of the screw nut 1. Alternatively, this layer 29 can be formed, for example, of a permeable material which can produce an effective reduction in the eddy currents induced in the metal by distorting the field lines. For this purpose, a suitable permeable material is used which, even at a frequency of, for example, 13.56 MHz, still does not exhibit excessive losses, i.e. only exhibits predetermined low losses. This material can be produced, for example, by mixing a suitable ferrite powder into a flexible plastic. This layer 29 is thus formed, for example, from plastic to which a ferrite powder is admixed, for example.

The use of RFID technology offers significant further advantages in addition to the realization of the described measuring function. In particular, the use of the non-volatile data memory present, in particular in the RFID transponder unit 8, for storage of information such as identification number, calibration data of the sensors, manufacturer and type information of the screw nut 1 as well as usage data is very advantageously applicable. In principle, RFID technology also offers the possibility of parallel measurement and reading of several screw nuts 1 designed as sensor nuts, which are located on the same side in the electromagnetic field 20 of the RFID reader 16, by means of typically implemented anti-collision algorithms

Furthermore, the special design of the RFID technology used as an NFC interface, for example, offers the possibility of reading out the measurement data with a cell phone, in particular a smartphone, or similar devices with an NFC interface, for example with a portable computer, in particular a tablet or notebook, and even displaying and processing it particularly easily when it is transmitted as an NDEF message.

### LIST OF REFERENCES

1 screw nut

2 assembly device

3 wrench

4 screw

5 sensor module

6 base body

7 deformation detection sensor

8 RFID transponder unit

9 printed circuit board

10 antenna

11 end face

12 feed-through opening

13 screw opening

14 side surface

15 cavity

16 RFID reader

17 protective cover

18 screw nut receptacle

19 recess

20 electromagnetic field

21 radio frontend

22 power management unit

23 microcontroller

24 analog-to-digital converter

25 electronic component

26 conductor tracks

27 electrical connection lines

28 display unit

29 layer

1. A screw nut comprising:
a base body having an end face; and
sensor module for determining a pretensioning force of a screw connection, wherein the sensor module comprises:
at least one deformation detection sensor arranged on the base body for detecting a deformation of the base body, and,
an RFID transponder unit having an antenna,
an electronic circuit,
a printed circuit board, on which the antenna and the electronic circuit are formed, which is electrically conductively coupled to the at least one deformation detection sensor, and which is arranged on the end face of the base body.

2. The screw nut according to claim 1,
wherein the base body has a screw opening,
wherein the printed circuit board is annular and has a feed-through opening, wherein a clear width of the feed-through opening is at least as large as a clear width of the screw opening.

3. The screw nut according to claim 1,
wherein the at least one deformation detection sensor is arranged in the region of an outer circumferential side of the base body.

4. The screw nut according to claim 3, wherein the base body has at least one side surface, wherein the at least one deformation detection sensor is arranged one of on the side surface, in a cavity formed in the side surface, and in an axial bore in the region of an edge between two adjacent side surfaces.

5. The screw nut according to claim 1,
wherein the at least one deformation detection sensor is designed as a sensor for detecting at least one of strains, compressions and/or shear forces.

6. The screw nut according to claim 1,
wherein the RFID transponder unit comprises an energy storage device.

7. The screw nut according to claim 1,
wherein the antenna is one of arranged and formed as a coil on the printed circuit board.

8. The screw nut according to claim 7, wherein the antenna is formed as a printed coil on the printed circuit board.

9. The screw nut according to claim 1,
wherein the sensor module comprises a plurality of deformation detection sensors, which are arranged around an outer circumference on the base body.

10. The screw nut according to claim 1, further comprising a protective cover for the sensor module.

11. A mounting device with comprising:
screw nut according to claim 1,
wrench,
an RFID reader which is one of fixedly connected to the wrench and detachably connectable to the wrench.

12. The screw nut according to claim 2,
wherein the printed circuit board is one of circular, elliptical and having a hexagonal outer contour.

13. The screw nut according to claim 5,
wherein the at least one deformation detection sensor is a strain gauge sensor.

14. The screw nut according to claim 6, wherein the energy storage device is a capacitor.

15. The screw nut according to claim 9,
wherein the plurality of deformation detection sensors is uniformly distributed around the outer circumference on the base body.

16. The mounting device of claim 11, wherein the deformation detection sensor has a region projecting beyond a surface of the base body, wherein the wrench has at least one screw nut receptacle comprising at least one recess for receiving the at least one deformation detection sensor, the recess being formed to correspond to the region.
